(19) United States
(12) Patent Application Publication
(10) Pub. No.: US 2025/0126234 A1
(43) Pub. Date: Apr. 17, 2025

(54) PROJECTION METHOD, PROJECTION APPARATUS, AND NON-TRANSITORY COMPUTER-READABLE STORAGE MEDIUM

(71) Applicant: SEIKO EPSON CORPORATION, Tokyo (JP)

(72) Inventor: Yutaro IIJIMA, MATSUMOTO-SHI (JP)

(21) Appl. No.: 18/912,650

(22) Filed: Oct. 11, 2024

(30) Foreign Application Priority Data
Oct. 12, 2023 (JP) 2023-176578

(51) Int. Cl. H04N 9/31; H04N 5/74

(52) U.S. Cl. CPC H04N 9/3185; H04N 5/74

(57) ABSTRACT

A projection method includes performing a calculation for high-speed correction of a shape of a projection image, projecting a provisional corrected image based on a calculation result thereof on a projection surface, performing a calculation for high-accuracy correction of the shape of the projection image, and projecting a settled corrected image based on a calculation result thereof on the projection surface. A processing time for obtaining the calculation result for the high-speed correction of the shape of the projection image is a first time, a processing time for obtaining the calculation result for the high-accuracy correction of the shape of the projection image is a second time longer than the first time, and the provisional corrected image is projected on the projection surface prior to the projection of the settled corrected image on the projection surface.

The present application is based on, and claims priority from JP Application Serial Number 2023-176578, filed Oct. 12, 2023, the disclosure of which is hereby incorporated by reference herein in its entirety.

### BACKGROUND

### 1. Technical Field

The present disclosure relates to a projection method, a projection apparatus, and a non-transitory computer-readable storage medium.

### 2. Related Art

JP-A-2015-186080 proposes a projector that corrects keystone distortion caused due to a tilt of a projection surface by measuring the tilt of the projection surface based on an image for measurement projected on the projection surface. Further, various configurations for correcting the keystone distortion including a configuration for correction in a simple manner and a configuration for correction with high accuracy are proposed in addition to the above described configuration.

JP-A-2015-186080 is an example of the related art.

However, in a configuration for correcting the keystone distortion with high accuracy, there is a problem that the correction takes a lot of time. When the correction of the keystone distortion takes a lot of time, a user is kept waiting for a desired image to be viewable, which causes the user to feel uncomfortable. On the other hand, in a configuration for correcting the keystone distortion in a simple manner, the correction can be performed in a short time, but accuracy of the correction is not sufficient and an image contour may be tilted.

### SUMMARY

A projection method according to an aspect of the present disclosure is a projection method of a projection image projected from a projection apparatus, including performing a first correction calculation for correcting a shape of the projection image, projecting a first projection image as the projection image based on a calculation result of the first correction calculation on a projection target, performing a second correction calculation for correcting the shape of the projection image, and projecting a second projection image as the projection image based on a calculation result of the second correction calculation on the projection target, wherein a processing time for obtaining the calculation result of the first correction calculation is a first time, a processing time for obtaining the calculation result of the second correction calculation is a second time longer than the first time, and the first projection image is projected on the projection target prior to the projection of the second projection image on the projection target.

A projection apparatus according to an aspect of the present disclosure comprises a projection optical system including a lens for projecting a projection image on a projection target, and one or more processors, wherein the one or more processors execute performing a first correction calculation for correcting a shape of the projection image, causing the projection optical system to project a first projection image as the projection image based on a calculation result of the first correction calculation on the projection target, performing a second correction calculation for correcting the shape of the projection image, and causing the projection optical system to project a second projection image as the projection image based on a calculation result of the second correction calculation on the projection target, a processing time for obtaining the calculation result of the first correction calculation is a first time, a processing time for obtaining the calculation result of the second correction calculation is a second time longer than the first time, and the one or more processors cause the projection optical system to project the first projection image on the projection target prior to causing the projection optical system to project the second projection image on the projection target. A non-transitory computer-readable storage medium according to an aspect of the present disclosure is a non-transitory computer-readable storage medium storing a program for a computer controlling a projection apparatus comprising a projection optical system including a lens for projecting a projection image on a projection target to execute performing a first correction calculation for correcting a shape of the projection image, causing the projection optical system to project a first projection image as the projection image based on a calculation result of the first correction calculation on the projection target, performing a second correction calculation for correcting the shape of the projection image, and causing the projection optical system to project a second projection image as the projection image based on a calculation result of the second correction calculation on the projection target, wherein a processing time for obtaining the calculation result of the first correction calculation is a first time, a processing time for obtaining the calculation result of the second correction calculation is a second time longer than the first time, and the computer causes the projection optical system to project the first projection image on the projection target prior to causing the projection optical system to project the second projection image on the projection target.

### BRIEF DESCRIPTION OF THE DRAWINGS

FIG. 1 is a block diagram showing an internal configuration of a projector.

FIG. 2 is a diagram showing a schematic configuration of an image projection unit provided in the projector.

FIG. 3 is a diagram for explanation of high-speed correction processing.

FIG. 4 is a diagram for explanation of high-accuracy correction processing.

FIG. 5 is a flowchart showing keystone distortion correction processing.

FIG. 6 is a flowchart showing high-speed correction processing according to a first embodiment.

FIG. 7 is a flowchart showing high-accuracy correction processing according to the first embodiment.

FIG. 8 is a flowchart showing high-accuracy correction processing according to a second embodiment.

FIG. 9 is a flowchart showing high-accuracy correction processing according to a third embodiment.

FIG. 10 is a flowchart showing high-accuracy correction processing according to a fourth embodiment.

### DESCRIPTION OF EMBODIMENTS

### 1. First Embodiment

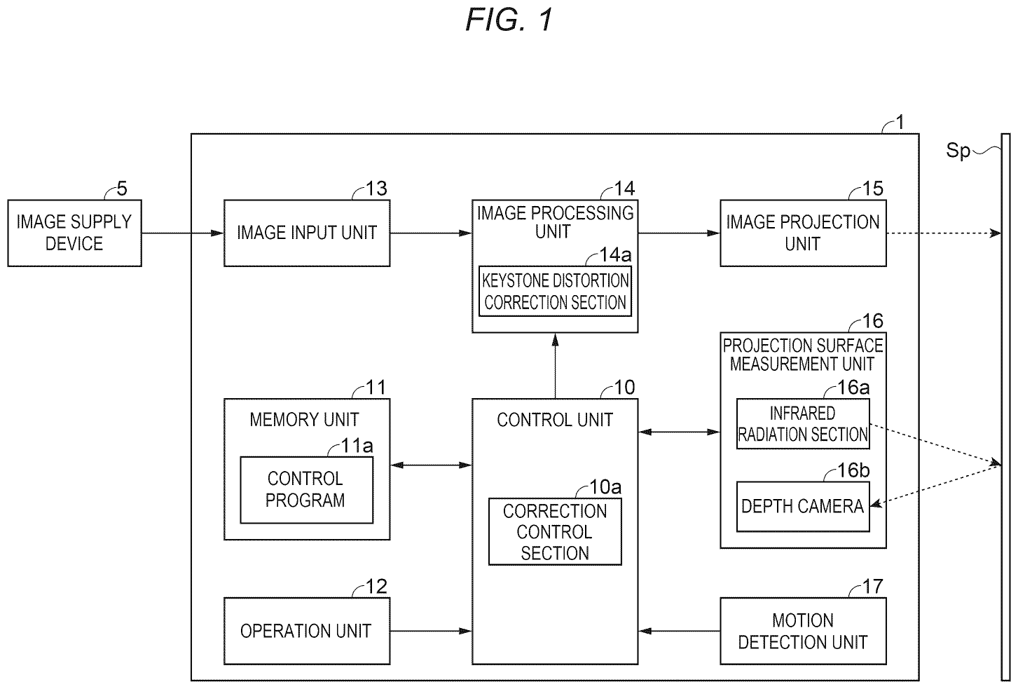

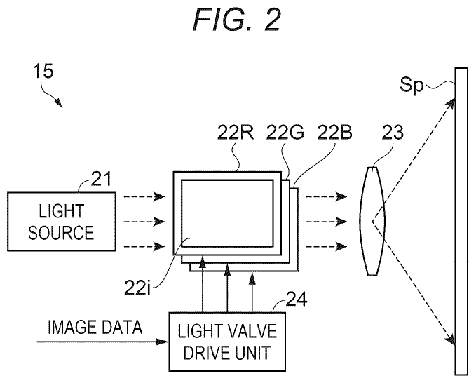

As below, a projector 1 according to a first embodiment will be described with reference to the drawings. FIG. 1 is a block diagram showing an internal configuration of the projector 1, and FIG. 2 is a diagram showing a schematic configuration of an image projection unit 15 provided in the projector 1.

As shown in FIG. 1, the projector 1 integrally includes a control unit 10, a memory unit 11, an operation unit 12, an image input unit 13, an image processing unit 14, the image projection unit 15, a projection surface measurement unit 16, and a motion detection unit 17. The projector 1 projects a projection image from the image projection unit 15 on a projection surface Sp based on image data input to the image input unit 13. The projector 1 is an example of a projection apparatus, and the projection surface Sp is an example of a projection target.

The control unit 10 includes one or more processors such as CPUs (Central Processing Unit), and operates according to a control program 11a stored in the memory unit 11 for integrated control of the operation of the projector 1. The control unit 10 corresponds to a computer. The computer may be a terminal device such as a personal computer that controls the projector 1.

The memory unit 11 has memories such as a RAM (Random-Access Memory) and a ROM (Read-Only Memory). The RAM is used for temporary storage of various data and the like, and the ROM stores the control program 11a for control of the operation of the projector 1, control data, image data, and the like. The control program 11a is an example of a program.

The operation unit 12 includes a plurality of operation keys (not shown) for a user u to give various instructions to the projector 1. When the user operates various operation keys of the operation unit 12, the operation unit 12 outputs operation signals corresponding to details of the operation by the user to the control unit 10. Note that a remote (not shown) that enables remote operation may be used as the operation unit 12. In this case, the remote transmits an infrared operation signal corresponding to the details of the operation by the user, and a remote signal receiver (not shown) receives and transmits the signal and transmits to the control unit 10.

The image input unit 13 includes a plurality of input terminals (not shown), and an external image supply device 5 such as a computer or an image reproduction device is coupled to each input terminal. The image input unit 13 receives the supply of image data from the image supply device 5, performs processing such as processing of converting a data format and processing of converting resolution on the supplied image data as necessary, and outputs the processed image data to the image processing unit 14.

The image processing unit 14 performs various kinds of adjustment processing on the image data input from the image input unit 13 under control of the control unit 10, and outputs the processed image data to a light valve driver 24 (see FIG. 2) of the image projection unit 15. For example, the image processing unit 14 performs processing of adjusting image quality, processing of correcting keystone distortion, processing of superimposing and displaying an OSD (On Screen Display) image such as a message or a menu on the displayed image, and the like on the image data. The image processing unit 14 may be implemented by one or more integrated circuits.

As shown in FIG. 2, the image projection unit 15 includes a light source 21, three liquid crystal light valves 22R, 22G, and 22B as light modulation devices, a projection optical system 23, the light valve driver 24, and the like. The image projection unit 15 modulates the light emitted from the light source 21 with the liquid crystal light valves 22R, 22G, and 22B to form an image light, and projects the image light from the projection optical system 23 including a lens to display a projection image on the projection surface Sp.

The light source 21 includes a solid-state light source such as a semiconductor laser or a light emitting diode, or a discharge light source lamp such as an ultrahigh-pressure mercury lamp or a metal halide lamp. The light emitted from the light source 21 is converted into a light having a substantially uniform luminance distribution by an optical integration system (not shown), is separated by a color separation system (not shown) into light components of respective colors of red, green, and blue as the three primary colors of light, and then, enter the liquid crystal light valves 22R, 22G, and 22B, respectively.

Each of the liquid crystal light valves 22R, 22G, and 22B includes a transmissive liquid crystal panel in which liquid crystal is enclosed between a pair of transparent substrates. In each liquid crystal panel, a rectangular pixel area 22i including a plurality of pixels arranged in a matrix form is formed, and a drive voltage can be selectively applied to each liquid crystal element forming each pixel.

The light valve driver 24 forms a projection image in the pixel areas 221 of the liquid crystal light valves 22R, 22G, and 22B. Specifically, the light valve driver 24 applies a drive voltage corresponding to the image data input from the image processing unit 14 to each pixel in the pixel area 22i, and sets each pixel at light transmittance corresponding to the image data. The light emitted from the light source 21 is transmitted through the pixel areas 221 of the liquid crystal light valves 22R, 22G, and 22B and modulated with respect to each pixel, and an image light corresponding to the image data is formed for each color light. The formed image lights of the respective colors are combined with respect to each pixel by a color combining system (not shown) and to be an image light representing a color image, and is enlarged and projected on the projection surface Sp by the projection optical system 23. As a result, a projection image based on the image data input from the image processing unit 14 is displayed on the projection surface Sp.

Returning to FIG. 1, the projection surface measurement unit 16 includes, for example, an infrared radiation section 16a and a depth camera 16b, and measures a tilt of the projection surface Sp. The depth camera 16b measures a reflected light of an infrared light radiated by the infrared radiation section 16a, thereby, acquires depth images by a so-called ToF (Time Of Flight) method, and outputs the acquired depth images to the control unit 10. The depth image as output of the depth camera 16b is an image in which a depth value corresponding to a distance from the projector 1 to the projection surface Sp in a direction parallel to the optical axis of the depth camera 16b is correlated with coordinates on a plane perpendicular to the optical axis of the depth camera 16b. Accordingly, the control unit 10 can acquire the tilt of the projection surface Sp by acquiring differences among the depth values in a plurality of positions on the projection surface Sp from the depth images. As described above, the depth camera 16b is a sensor for detecting the tilt of the projection surface Sp, and corresponds to a second sensor.

The image processing unit 14 includes a keystone distortion correction section 14a. The keystone distortion correction section 14a corrects distortion of the projection image, i.e., keystone distortion caused when the projection surface Sp is tilted with respect to the optical axis of the projector 1, i.e., the optical axis of the projection optical system 23 under control of the control unit 10. Specifically, the keystone distortion correction section 14a performs processing of deforming the projection image into a shape that can cancel out the keystone distortion so that the projection image is a rectangle as an original shape on the projection surface Sp tilted with respect to the optical axis of the projection optical system 23 based on correction information input from the control unit 10. Correction of the keystone distortion corresponds to correction of the shape of the projection image.

The control unit 10 includes a correction control section 10a that controls keystone distortion correction processing as a functional unit implemented by the control program 11a. The correction control section 10a calculates the tilt of the projection surface Sp based on a measurement result of the projection surface measurement unit 16, and derives correction information for correction of the keystone distortion caused when the projection image is projected on the projection surface Sp. Then, the correction control section 10a outputs the derived correction information to the keystone distortion correction section 14a. The correction information is information with which a shape of a projection image to be formed in the pixel area 22i can be specified, and may be, for example, an expression expressing a normal line of the projection surface Sp or coordinates of four corners of a projection image in a two-dimensional coordinate system set for the pixel area 221. Note that the position of the depth camera 16b in the projector 1, the direction of the optical axis of the depth camera 16b, the position of the projection optical system 23, and the direction of the optical axis of the projection optical system 23 are fixed, and the correction control section 10a can derive the tilt of the projection surface Sp with respect to the optical axis of the projection optical system 23 from the depth images based on their mutual relationships. Then, the correction control section 10a controls the keystone distortion correction section 14a to correct the keystone distortion according to the tilt of the projection surface Sp with respect to the optical axis of the projection optical system 23.

The motion detection unit 17 includes, for example, a gyro sensor, and detects an attitude of the projector 1 and outputs a detection result to the control unit 10. The control unit 10 determines that the projector 1 is stationary when the variation range of the attitude based on the output of the motion detection unit 17 is within a predetermined range, and determines that the projector 1 is moving when the variation range of the attitude exceeds the predetermined range. Note that the motion detection unit 17 is not limited to the gyro sensor, but other sensors such as an acceleration sensor can be used. Further, the motion detection unit 17 may detect variations of the attitude of the projector 1 based on a measurement result of the projection surface measurement unit 16, that is, variations of the distance from the projector 1 to the projection surface Sp. The motion detection unit 17 corresponds to a first sensor for detecting the attitude of the projector 1. The above described predetermined range corresponds to a first range.

Next, correction processing for correcting the keystone distortion will be described.

The projector 1 of the embodiment can execute two types of correction processing of high-speed correction processing and high-accuracy correction processing as processing for correcting keystone distortion. The high-speed correction processing is correction processing in which the processing time is shorter than that of the high-accuracy correction processing, while the accuracy of the correction is lower than that of the high-accuracy correction processing. The high-accuracy correction processing is correction processing in which the accuracy of correction is higher than that of the high-speed correction processing, while the processing time is longer than that of the high-speed correction processing. In the embodiment, the number of times the projection surface measurement unit 16 measures the projection surface Sp, that is, the number of times the depth image is acquired is different between the high-speed correction processing and the high-accuracy correction processing. Specifically, the high-accuracy correction processing acquires more depth images than the high-speed correction processing. Accordingly, the high-accuracy correction processing requires a longer processing time than the high-speed correction processing.

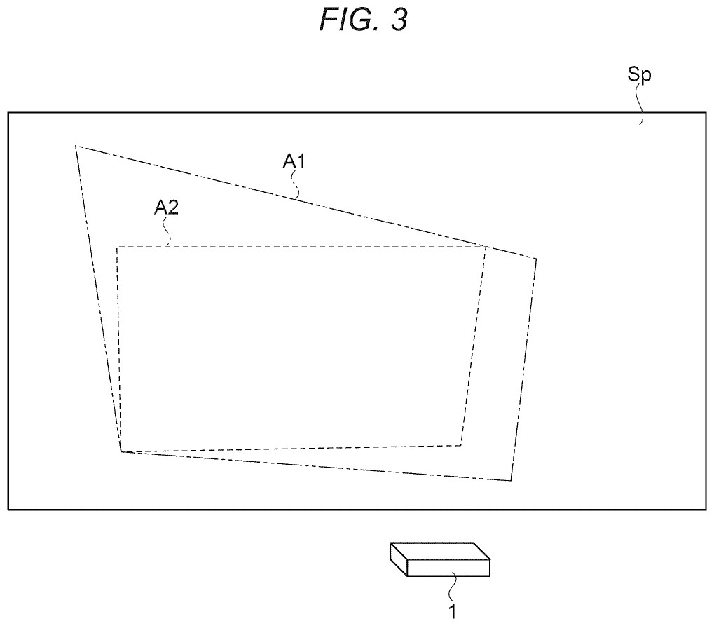

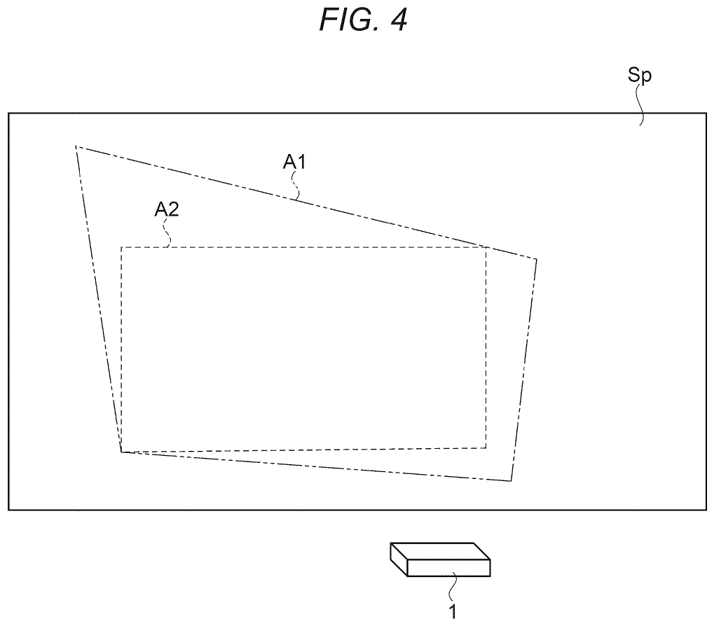

FIG. 3 is a diagram for explanation of the high-speed correction processing, and FIG. 4 is a diagram for explanation of the high-accuracy correction processing. In both drawings, an area A1 surrounded by a two-dot chain line indicates an area where a projection image is displayed when the correction processing is not performed, and an area A2 surrounded by a broken line indicates an area where a projection image is displayed when the correction processing is performed. When the correction processing is performed, in the pixel areas 221 of the liquid crystal light valves 22R, 22G, and 22B, areas corresponding to the outside of the areas A2 inside the areas A1 are set in black not to transmit light. That is, in the pixel area 221, a significant image is formed in an area corresponding to the area A2. In this specification, “projection image” refers to an image displayed in the area A2 among the images formed in the pixel area 221.

In the high-speed correction processing of the embodiment, the tilt of the projection surface Sp is calculated based on a result of single measurement of the projection surface Sp, that is, one depth image, and the keystone distortion is corrected according to the tilt. On the other hand, in the high-accuracy correction processing of the embodiment, the tilt of the projection surface Sp is calculated based on a result of a plurality of measurements of the projection surface Sp performed at time intervals, that is, a plurality of depth images, and the keystone distortion is corrected according to the tilt. Since the measurement result of the projection surface measurement unit 16 may include an error due to various factors, the accuracy of correction is low in the single measurement. That is, in this case, the shape of the projection image, that is, the shape of the area A2 is not likely to be an accurate rectangle as shown in FIG. 3, and the contour is often tilted. On the other hand, when the measurement of the projection surface Sp is performed at a plurality of times at time intervals and the tilt of the projection surface Sp is determined by the least squares method or the averaging method, the influence of the error is reduced. Therefore, as shown in FIG. 4, the shape of the projection image, that is, the shape of the area A2 is closer to a rectangle than that when the measurement is performed once. However, in the high-accuracy correction processing, since a plurality of measurements are required and relatively complicated calculations are required, the processing time required for the correction processing is longer than that in the high-speed correction processing.

That is, when the processing time for obtaining the calculation result of the tilt of the projection surface Sp by the high-speed correction processing is a first time, and the processing time for obtaining the calculation result of the tilt of the projection surface Sp by the high-accuracy correction processing is a second time, the second time is longer than the first time. Here, the processing time for obtaining the calculation result includes a time for measuring the projection surface Sp and a time for performing calculation for calculating the tilt of the projection surface Sp. Therefore, the first time is a period from a start time at which the measurement of the projection surface Sp, that is, acquisition of the information on the projection surface Sp is started, to a first calculation end time at which the calculation result of the tilt of the projection surface Sp is obtained by the high-speed correction processing, and the second time is a period from the start time to a second calculation end time at which the calculation result of the tilt of the projection surface Sp is obtained by the high-accuracy correction processing. The depth camera 16b starts the measurement of the projection surface Sp in response to reception of a trigger signal for giving an instruction to start the measurement of the projection surface Sp from the control unit 10. The start time at which the acquisition of the information on the projection surface Sp is started by the depth camera 16b is, for example, a time at which the depth camera 16b starts imaging of the projection surface Sp or a time at which the depth camera 16b receives the trigger signal for giving the instruction to start imaging of the projection surface output from the control unit 10. The time for the measurement of the projection surface Sp is the time required to acquire the information on the projection surface Sp, that is, the depth image. Accordingly, the larger the number of depth images to be measured, the longer the time for the measurement of the projection surface Sp. Further, the larger the number of depth images to be measured, the larger the volume of data, and the larger the number of depth images to be measured, the longer the time for calculation of the tilt of the projection surface Sp.

Note that the high-speed correction processing may be performed based on the output from the second sensor of a first type, and the high-accuracy correction processing may be performed based on the output from the second sensor of a second type different from the first type. For example, the second sensor of the first type is an ultrasonic sensor (not shown), and the second sensor of the second type is the depth camera 16b. In this case, the start time at which the acquisition of the information on the projection surface Sp is started by the ultrasonic sensor is, for example, the time at which the ultrasonic sensor starts to emit the ultrasonic wave, or the time at which the ultrasonic sensor receives a second trigger signal for giving an instruction to start the emission of the ultrasonic wave output from the control unit 10. The ultrasonic sensor measures the projection surface Sp once. The rising timing of the trigger signal for instructing the depth camera 16b to start imaging of the projection surface Sp output from the control unit 10 is preferably synchronized with the rising timing of the second trigger signal for instructing the ultrasonic sensor to start emission of the ultrasonic wave output from the control unit 10. The trigger signal is synchronized with the second trigger signal, and thereby, the start time at which the second sensor of the first type starts the measurement of the projection surface Sp may be set to the same time as the start time at which the second sensor of the second type starts the measurement of the projection surface Sp.

In the embodiment, the correction control section 10a repeatedly executes the high-speed correction processing when the projector 1 is moving as in the case where the user is adjusting the attitude of the projector 1. Then, after the projector 1 becomes stationary, the high-accuracy correction processing is executed. Hereinafter, the projection image corrected by the high-speed correction processing is also referred to as “provisional corrected image”, and the projection image corrected by the high-accuracy correction processing is also referred to as “settled corrected image”. The provisional corrected image is provisionally projected in a period until the settled corrected image is projected on the projection surface Sp. In the embodiment, the contents indicated by the provisional corrected image are the same as the contents indicated by the settled corrected image except that the precision of the correction, that is, the outer shape is different.

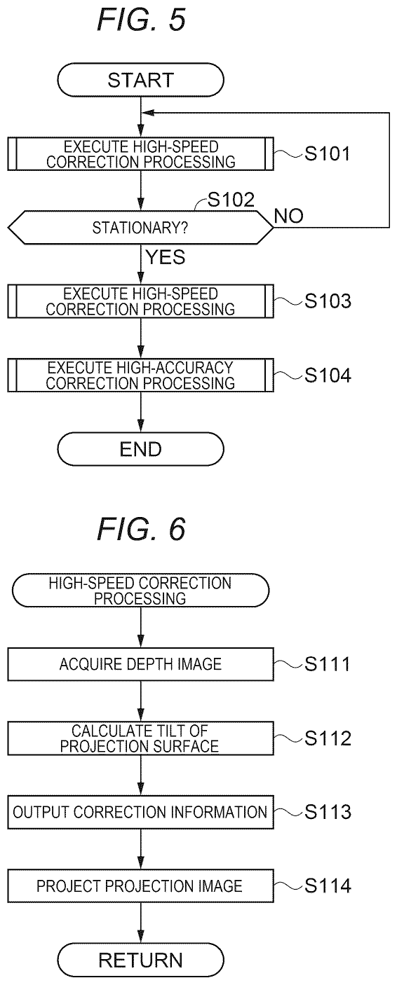

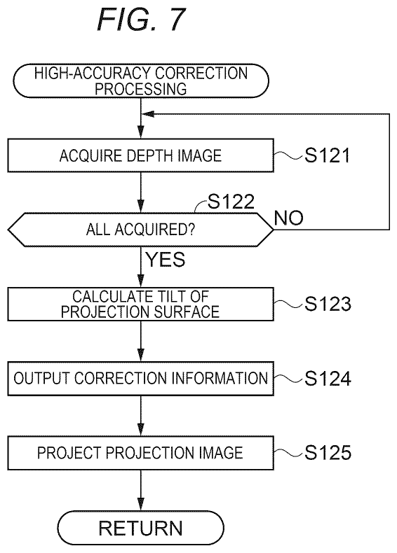

FIG. 5 is a flowchart showing the keystone distortion correction processing. FIG. 6 is a flowchart showing the high-speed correction processing according to the first embodiment, and FIG. 7 is a flowchart showing the high-accuracy correction processing according to the first embodiment. The flowcharts shown in FIGS. 5 to 7 show a part of a projection method of the projector 1. When the projector 1 is activated, the control unit 10 starts an operation according to the control program 11a and, after finishing a predetermined initial operation, starts projection of the projection image based on the image data supplied from the image supply device 5.

After starting the projection of the projection image, the control unit 10 monitors the motion of the projector 1 based on the detection result of the motion detection unit 17. When the variation range of the attitude of the projector 1 is beyond the predetermined range in a case where the user is moving the projector 1 to adjust the position and size of the projection image on the projection surface Sp or the like, the control unit 10 determines that the projector 1 is moving. When determining that the projector 1 is moving, the control unit 10 starts the correction processing according to the flow shown in FIG. 5, and corrects the keystone distortion caused by the motion of the projector 1. The predetermined range is a variation range of the attitude of the projector 1 such that the motion of the projector 1 appears to be substantially stationary as seen from the user, and determined in advance based on a result of an experiment, a simulation, a sensory test, or the like.

At step S101, the correction control section 10a of the control unit 10 executes the high-speed correction processing. Specifically, as shown in FIG. 6, the correction control section 10a acquires the depth image from the projection surface measurement unit 16 (step S111), and calculates the tilt of the projection surface Sp based on the acquired depth image (step S112). Then, the correction control section 10a outputs correction information corresponding to the calculated tilt of the projection surface Sp to the keystone distortion correction section 14a (step S113). When the keystone distortion correction section 14a executes the correction processing based on the correction information, as shown in FIG. 3, the image projection unit 15 of the projector 1 projects a provisional corrected image in which the keystone distortion is suppressed to some extent (step S114). That is, the correction control section 10a outputs the correction information to the keystone distortion correction section 14a, and thereby, controls the projection optical system 23 of the image projection unit 15 to project the projection image corrected according to the correction information. The calculation for calculating the tilt of the projection surface Sp at step S112 corresponds to a first correction calculation. The provisional corrected image projected at step S114 is a projection image based on the calculation result of the first correction calculation, and corresponds to a first projection image.

Returning to FIG. 5, at step S102, the correction control section 10a determines whether the projector 1 is stationary based on the output from the motion detection unit 17. For example, the correction control section 10a determines that the projector 1 is stationary when the variation range of the attitude of the projector 1 falls within the predetermined range and this state continues for a predetermined time. On the other hand, when the variation range of the attitude of the projector 1 is still beyond the predetermined range, the correction control section 10a determines that the projector 1 is moving. When the projector 1 is stationary (step S102: YES), the correction control section 10a shifts the processing to step S103. On the other hand, when the projector 1 is moving (step S102: NO), the correction control section 10a returns the processing to step S101. Then, the correction control section 10a repeats the high-speed correction processing until the projector 1 becomes stationary, that is, until the variation range of the attitude of the projector 1 falls within the predetermined range.

When the projector 1 becomes stationary and the processing goes to step S103, the correction control section 10a executes the high-speed correction processing again. Thereby, a provisional corrected image corrected based on the depth image acquired in the stationary state is projected on the projection surface Sp. Therefore, during the high-accuracy correction processing to be described later, the provisional corrected image is projected in a shape closer to the original shape as compared with the provisional corrected image corrected based on the depth image acquired when the projector 1 is moving. However, step S103 may be omitted.

Next, at step S104, the correction control section 10a executes the high-accuracy correction processing. Specifically, as shown in FIG. 7, the correction control section 10a acquires the depth image from the projection surface measurement unit 16 (step S121). Then, the correction control section 10a determines whether all the depth images at the required number of times are acquired (step S122), and when not all the depth images are acquired (step S122: NO), repeats the acquisition of the depth images (step S121) until all the depth images are acquired. On the other hand, when all the depth images are acquired (step S122: YES), the correction control section 10a calculates the tilt of the projection surface Sp using the least squares method or the like based on the plurality of acquired depth images (step S123), and derives correction information corresponding to the tilt. Then, the correction control section 10a outputs the derived correction information to the keystone distortion correction section 14a (step S124). When the keystone distortion correction section 14a executes the correction processing based on the correction information, as shown in FIG. 4, the image projection unit 15 of the projector 1 projects a settled corrected image in which the keystone distortion is corrected with high accuracy (step S125). That is, the correction control section 10a outputs the correction information to the keystone distortion correction section 14a, and thereby, controls the projection optical system 23 of the image projection unit 15 to project the projection image corrected according to the correction information. The calculation for calculating the tilt of the projection surface Sp at step S123 corresponds to a second correction calculation. Further, the settled corrected image projected at step S125 is a projection image based on the calculation result of the second correction calculation, and corresponds to a second projection image.

The number of acquisitions of the depth image in the high-accuracy correction processing is not particularly limited, and may be about several times or 100 or more times. For example, when the depth image is acquired at a frame frequency of 30 Hz, it takes 3 seconds or more to acquire the depth image at 100 times.

After executing the high-accuracy correction processing, the correction control section 10a ends the series of correction processing.

As described above, according to the projection method, the projector 1, and the control program 11a of the embodiment, the following effects can be obtained.

According to the embodiment, the projector 1 projects the provisional corrected image corrected by the high-speed correction processing on the projection surface Sp prior to projecting the settled corrected image corrected by the high-accuracy correction processing on the projection surface Sp. That is, the provisional corrected image corrected in a shorter time is projected on the projection surface Sp until the settled corrected image corrected in a longer time is projected. Therefore, an uncomfortable feeling caused by a long waiting time until the settled corrected image is projected on the projection surface Sp may be reduced.

According to the embodiment, when the projector 1 is moving as in the case where the user is adjusting the attitude of the projector 1, the provisional corrected image corrected in a short time is projected and, after the attitude of the projector 1 becomes stationary, the settled corrected image is projected. Therefore, the corrected projection image can be projected before the attitude of the projector 1 becomes stationary.

According to the embodiment, since both the high-speed correction processing and the high-accuracy correction processing are performed based on the output from the common depth camera 16b, the algorithm of the correction processing can be shared between the high-speed correction processing and the high-accuracy correction processing.

### 2. Second Embodiment

As below, a projector 1 according to a second embodiment will be described with reference to the drawings. Since the projector 1 of the embodiment has the same hardware configuration as that of the projector 1 of the first embodiment, the description thereof will be omitted. In the second embodiment, the operation of the projector 1 in the high-accuracy correction processing is different from that in the first embodiment.

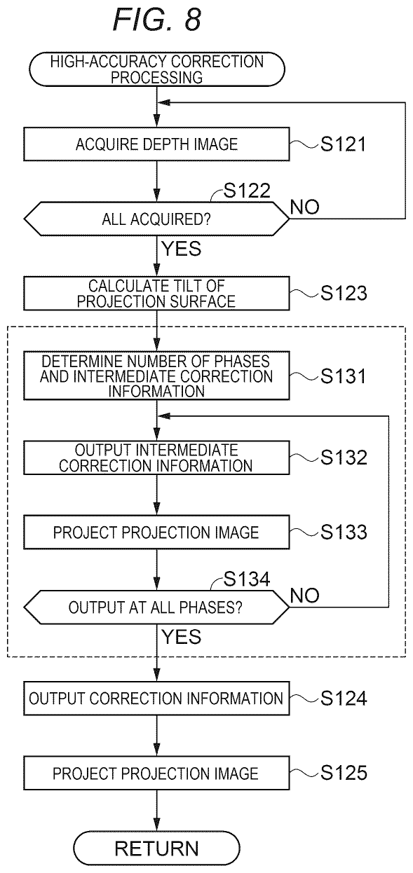

FIG. 8 is a flowchart showing high-accuracy correction processing according to the second embodiment.

The projection method of the embodiment includes steps S131 to S134 between step S123 and step S124. Operations at steps other than steps S131 to S134 are the same as those in the first embodiment, and the description thereof will be omitted.

The correction control section 10a executes steps S131 to S134 after calculating the tilt of the projection surface Sp based on the plurality of depth images at step S123 and before outputting the correction information corresponding to the calculated tilt of the projection surface Sp to the keystone distortion correction section 14a at step S124.

At steps S131 to S134, the correction control section 10a gradually changes the shape of the projection image from the shape of the projection image currently being projected, that is, the shape of the provisional corrected image determined by the last high-speed correction processing (step S103) to the shape of the settled corrected image determined by the high-accuracy correction processing.

Specifically, first, at step S131, the correction control section 10a determines the number of phases for changing the projection image according to the degree of difference between the shape of the provisional corrected image currently being projected and the shape of the settled corrected image corresponding to the tilt of the projection surface Sp determined at step S123. Here, the larger the difference between the shapes of the projection images, the larger the number of phases is determined. Further, the correction control section 10a determines intermediate correction information as correction information corresponding to the shape of the projection image at each phase. Note that the number of phases may be fixed.

Then, at step S132, the correction control section 10a outputs the intermediate correction information corresponding to the shape of the projection image at the current phase to the keystone distortion correction section 14a. When the keystone distortion correction section 14a executes the correction processing based on the intermediate correction information, at step S133, the image projection unit 15 of the projector 1 projects the projection image in a shape closer to the shape of the settled corrected image by one phase.

Then, at step S134, the correction control section 10a determines whether the intermediate correction information is output at all phases determined at step S131. When the intermediate correction information is output at not all phases (step S134: NO), the correction control section 10a returns the processing to step S132, outputs the intermediate correction information at the next phase to the keystone distortion correction section 14a, and subsequently repeats the above described operations. On the other hand, when the intermediate correction information is output at all phases (step S134: YES), the correction control section 10a shifts the processing to step S124, and outputs the correction information corresponding to the tilt of the projection surface Sp calculated at step S123, that is, the correction information corresponding to the shape of the settled corrected image to the keystone distortion correction section 14a.

As described above, according to the embodiment, since the shape of the projection image gradually changes from the shape of the projection image determined by the last high-speed correction processing toward the shape of the projection image determined by the high-accuracy correction processing little by little, the shape of the projection image does not change abruptly, and thus the user's uncomfortable feeling can be reduced.

### 3. Third Embodiment

As below, a projector 1 according to a third embodiment will be described with reference to the drawings. Since the projector 1 of the embodiment has the same hardware configuration as that of the projector 1 of the first embodiment, the description thereof will be omitted. In the third embodiment, the operation of the projector 1 in the high-accuracy correction processing is different from that in the first embodiment.

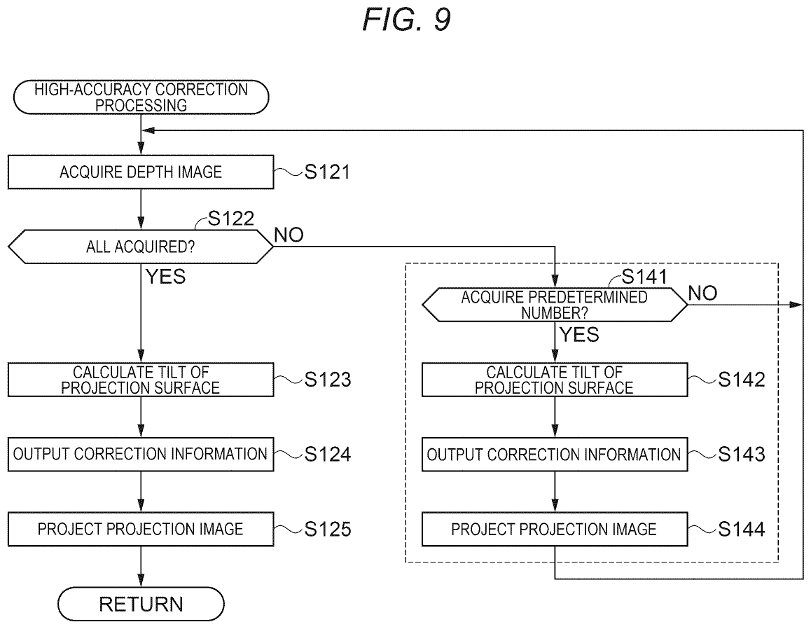

FIG. 9 is a flowchart showing high-accuracy correction processing according to the third embodiment.

The projection method of the embodiment includes steps S141 to S144 in addition to steps S121 to S125 in the first embodiment. Operations at steps other than steps S141 to S144 are the same as those in the first embodiment, and the description thereof will be omitted.

At step S122, the correction control section 10a determines whether all the depth images corresponding to the required number of times are acquired. When all the depth images are acquired (step S122: YES), the section shifts the processing to step S123 as in the first embodiment. On the other hand, when not all the depth images are acquired (step S122: NO), the correction control section 10a shifts the processing to step S141.

At step S141, the correction control section 10a determines whether the number of acquired depth images reaches a predetermined number. Here, the predetermined number is set to a value smaller than the number of depth images required for the high-accuracy correction processing. For example, when the number of depth images required for the high-accuracy correction processing is 100, the predetermined number may be set to 20. When the number of acquired depth images does not reach the predetermined number (step S141: NO), the correction control section 10a returns the processing to step S121, and when the number of acquired depth images reaches the predetermined number (step S141: YES), shifts the processing to step S142.

At step S142, the correction control section 10a calculates the tilt of the projection surface Sp based on the predetermined number of acquired depth images, and derives correction information corresponding to the tilt. Then, at step S143, the correction control section 10a outputs the derived correction information to the keystone distortion correction section 14a. When the keystone distortion correction section 14a executes the correction processing based on the correction information, at step S144, the image projection unit 15 of the projector 1 projects the projection image in a corrected state to some extent. Then, the correction control section 10a resets the counter for determination as to whether the number of depth images reaches the predetermined number to zero, and returns the processing to step S121.

In the embodiment, according to the above described operation, the shape of the projection image is updated at each time when the predetermined number of depth images are acquired during the execution of the high-accuracy correction processing. After all the required depth images are acquired, the shape of the projection image becomes the shape of the finally settled corrected image. For example, when the number of depth images required for the high-accuracy correction processing is 100 and the predetermined number is 20, the shape of the projection image is updated at the timing when the number of acquired depth images becomes 20, 40, 60, and 80 as multiple numbers of 20, and is projected in the final shape when the number of acquired depth images becomes 100.

As described above, according to the embodiment, the same effects as those of the second embodiment can be obtained.

### 4. Fourth Embodiment

As below, a projector 1 according to a fourth embodiment will be described with reference to the drawings. Since the projector 1 of the embodiment has the same hardware configuration as that of the projector 1 of the first embodiment, the description thereof will be omitted. In the fourth embodiment, the operation of the projector 1 in the high-speed correction processing is different from that in the first embodiment. Specifically, the projector 1 performs an operation in which the operation of the high-accuracy correction processing in the second embodiment is applied to the high-speed correction processing.

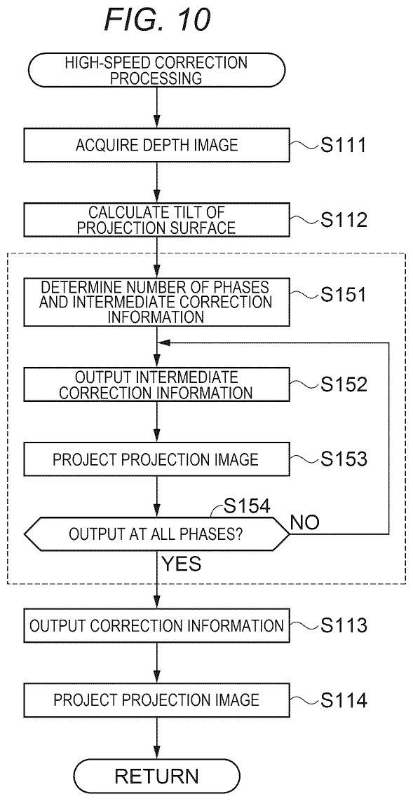

FIG. 10 is a flowchart showing the high-speed correction processing according to the fourth embodiment.

The projection method of the embodiment includes steps S151 to S154 between step S112 and step S113. Operations at steps other than steps S151 to S154 are the same as those in the first embodiment, and the description thereof will be omitted.

The correction control section 10a executes steps S151 to S154 after calculating the tilt of the projection surface Sp based on one depth image at step S112 and before outputting correction information corresponding to the calculated tilt of the projection surface Sp to the keystone distortion correction section 14a at step S113.

At steps S151 to S154, the correction control section 10a gradually changes the shape of the projection image from an initial shape determined before the high-speed correction processing to a shape of a provisional corrected image determined by the high-speed correction processing little by little. Here, the initial shape may be a shape before the correction processing is performed, or may be a shape determined by the previous correction processing.

First, at step S151, the correction control section 10a determines the number of phases for changing the projection image according to the degree of difference between the initial shape and the shape of the provisional corrected image corresponding to the tilt of the projection surface Sp determined at step S112. Here, the larger the difference between the shapes of the projection images, the larger the number of phases is determined. Further, the correction control 10a determines intermediate correction information as correction information corresponding to the shape of the projection image at each phase. Note that the number of phases may be fixed.

Then, at step S152, the correction control section 10a outputs the intermediate correction information corresponding to the shape of the projection image at the current phase to the keystone distortion correction section 14a. When the keystone distortion correction section 14a executes the correction processing based on the intermediate correction information, at step S153, the image projection unit 15 of the projector 1 projects the projection image in a shape closer to the shape of the provisional corrected image by one phase.

Then, at step S154, the correction control section 10a determines whether the intermediate correction information is output at all phases determined at step S151. When the intermediate correction information is output at not all phases (step S154: NO), the correction control section 10a returns the processing to step S152, outputs the intermediate correction information at the next phase to the keystone distortion correction section 14a, and subsequently repeats the above described operations. On the other hand, when the intermediate correction information is output at all phases (step S154: YES), the correction control section 10a shifts the processing to step S113, and outputs correction information corresponding to the tilt of the projection surface Sp calculated at step S112, that is, correction information corresponding to the shape of the provisional corrected image to the keystone distortion correction section 14a.

As described above, according to the embodiment, since the shape of the projection image gradually changes toward the shape of the provisional corrected image determined by the high-speed correction processing little by little, the shape of the projection image does not change abruptly, and the user's uncomfortable feeling can be reduced.

Note that the high-speed correction processing according to the embodiment may be combined with the high-accuracy correction processing according to any one of the first to third embodiments. Further, the high-speed correction processing at step S101, that is, the high-speed correction processing before the projector 1 becomes stationary may be performed as the high-speed correction processing according to the first embodiment, and the high-speed correction processing at step S103, that is, the high-speed correction processing after the projector 1 becomes stationary may be performed as the high-speed correction processing according to the fourth embodiment.

### 5. Modified Examples

The above described embodiments can be modified as below.

In each of the above described embodiments, the image processing unit 14 may add a frame-shaped image to the peripheral edge of the provisional corrected image. According to the configuration, the user may be notified that the current projection image is a provisional corrected image, but not a final settled corrected image. Further, the image processing unit 14 may perform blurring processing on the peripheral edge of the provisional corrected image. According to the configuration, similarly, the user may be notified that the current projection image is a provisional corrected image, and the tilted contour of the projection image may be obscured. As described above, when the projection image corrected by the high-speed correction processing is projected, it is desirable to notify the user that the projection image is a provisional corrected image by making the form of the peripheral edge of the projection image different from the form of another area than the peripheral edge. Further, message or the like for notifying the user that the projection image is a provisional corrected image may be superimposed on the projection image.

In each of the above described embodiments, one depth image is used for calculation of the tilt of the projection surface Sp in the high-speed correction processing, and a plurality of depth images are used in the high-accuracy correction processing, however, the present disclosure is not limited to the configuration. For example, a plurality of depth images may be used in the high-speed correction processing as long as the number of depth images used in the high-accuracy correction processing is larger than the number of depth images used in the high-speed correction processing. In other words, the calculation of the tilt of the projection surface Sp in the high-speed correction processing may be performed based on the output by a first number of times from the depth camera 16b, and the calculation of the tilt of the projection surface Sp in the high-accuracy correction processing may be performed based on the output by a second number of times larger than the first number of times from the depth camera 16b. When the high-speed correction processing is performed using a plurality of depth images, the tilt of the projection surface Sp may be obtained by using the least squares method or averaging as in the high-accuracy correction processing.

In addition, among the depth values contained in the depth images having predetermined resolution, the number of depth values used for calculation of the tilt of the projection surface Sp may be different between the high-speed correction processing and the high-accuracy correction processing. Specifically, the number of depth values used for calculation of the tilt of the projection surface Sp in the high-speed correction processing may be set to be smaller than the number of depth values used for calculation of the tilt of the projection surface Sp in the high-accuracy correction processing. In this case, the number of depth images used in the high-speed correction processing and the number of depth images used in the high-accuracy correction processing may be the same.

In each of the above described embodiments, the high-speed correction processing and the high-accuracy correction processing are performed based on the output from the depth camera 16b for detecting the tilt of the projection surface Sp, however, the present disclosure is not limited to the configuration. For example, the high-speed correction processing and the high-accuracy correction processing may be performed based on output from a sensor for detecting the attitude of the projector 1 such as an acceleration sensor, a gyro sensor, or a geomagnetic sensor in addition to the above described combination of the depth camera 16b and the ultrasonic sensor, or may be performed based only on output from another second sensor for detecting the tilt of the projection surface Sp, e.g., an ultrasonic sensor. Further, as described above, different sensors may be used in the high-speed correction processing and the high-accuracy correction processing. For example, the tilt of the projection surface Sp in the high-speed correction processing may be calculated based on output from a sensor for detecting the attitude of the projector 1, and the tilt of the projection surface Sp in the high-accuracy correction processing may be calculated based on output from the depth camera 16b. According to the configuration, the shape of the projection image may be appropriately corrected based on output from a sensor suitable for each of the high-speed correction processing and the high-accuracy correction processing. In the configuration, the sensor for detecting the attitude of the projector 1 corresponds to the first sensor like the sensor forming the motion detection unit 17. That is, the sensor forming the motion detection unit 17 may also serve as the sensor used for the high-speed correction processing.

When the second sensors of the same type, for example, the depth camera 16b are used in the high-speed correction processing and the high-accuracy correction processing as in the above described embodiments, the number of data on the projection surface Sp acquired by the second sensor in the high-speed correction processing may be the same as the number of data on the projection surface Sp acquired by the second sensor in the high-accuracy correction processing, and the correction algorithm for keystone distortion used in the high-speed correction processing may be different from the correction algorithm for keystone distortion used in the high-accuracy correction processing. The calculation time of the correction algorithm for keystone distortion used in the high-speed correction processing is shorter than the calculation time of the correction algorithm for keystone distortion used in the high-accuracy correction processing.

Among sensors for detecting the attitude of the projector 1, the acceleration sensor is suitable for the high-speed correction processing, and can also be used for the high-accuracy correction processing by averaging or appropriate exclusion of outliers. Further, the geomagnetic sensor can be used for the high-speed correction processing, and can also be used for the high-accuracy correction processing by averaging of a plurality of detection results or using the least squares method or the like. On the other hand, the gyro sensor is desirably used only for the high-speed correction processing because of drift. Note that, in the high-speed correction processing, when the attitude or the like of the projector 1 is calculated from a small number of detection values, averaging or smoothing using a Kalman filter may be performed. In at least one of the high-speed correction processing and the high-accuracy correction processing, a combination of detection results of the plurality of exemplified sensors may be used. In this case, an extended Kalman filter or the like may be used to estimate the attitude or the like of the projector 1.

In each of the above described embodiments, the planar projection surface Sp is the projection target of the projector 1, however, the projection target may be a non-planar object such as a three-dimensional object. In addition, when the depth camera 16b has certain resolution, the shape and the surface condition such as unevenness of the projection target may be measured. Accordingly, the image processing unit 14 may perform correction according to the shape of the projection target or correction of distortion caused by the surface condition of the projection target. In this case, the depth camera 16b as the second sensor functions as a sensor for detecting the condition of the projection target including the tilt, the shape, the surface condition, and the like of the projection target.

In each of the above described embodiments, the projection surface measurement unit 16 includes the depth camera 16b that outputs the depth image containing a plurality of depth values, however, the configuration of the projection surface measurement unit 16 is not limited to the configuration. For example, the projection surface measurement unit may have a configuration in which a plurality of depth sensors each acquiring and outputting one depth value by the ToF method are arranged.

In the above described embodiment, the transmissive liquid crystal light valves 22R, 22G, and 22B are used as the light modulation devices, however, reflective light modulation devices such as reflective liquid crystal light valves can also be used. Further, a digital mirror device that modulates the light emitted from the light source 21 by controlling the emission direction of the incident light with respect to each micromirror as a pixel or the like can be used. Furthermore, not limited to the configuration including the plurality of light modulation devices for the respective color lights, but a configuration modulating a plurality of color lights in a time-division manner by one light modulation device may be employed.

### 6. Summary of Present Disclosure

The summary of the present disclosure will be appended as below.
(Appendix 1) A projection method of a projection image projected from a projection apparatus, includes performing a first correction calculation for correcting a shape of the projection image, projecting a first projection image as the projection image based on a calculation result of the first correction calculation a the projection target, performing a second correction calculation for correcting the shape of the projection image, and projecting a second projection image as the projection image based on a calculation result of the second correction calculation on the projection target, wherein a processing time for obtaining the calculation result of the first correction calculation is a first time, a processing time for obtaining the calculation result of the second correction calculation is a second time longer than the first time, and the first projection image is projected on the projection target prior to the projection of the second projection image on the projection target.

According to the projection method, the first projection image is projected on the projection target prior to the projection of the second projection image on the projection target. That is, the first projection image corrected in a shorter time is projected until the second projection image corrected in a longer time is projected on the projection target. Therefore, an uncomfortable feeling caused by a long waiting time until the second projection image is projected on the projection target may be reduced.
(Appendix 2) In the projection method according to Appendix 1, whether a variation range of an attitude of the projection apparatus falls within a first range is determined based on output from a first sensor for detecting the attitude, when a determination that the variation range does not fall within the first range is made, the first projection image is projected on the projection target and, when a determination that the variation range falls within the first range is made, the second projection image is projected on the projection target.

According to the projection method, when the projection apparatus is moving as in a case where the user is adjusting the attitude of the projection apparatus, the first projection image corrected in a shorter time is projected. Then, after the attitude of the projection apparatus becomes stationary, the second projection image corrected in a longer time is projected. Therefore, the projection image may be projected in a corrected state before the attitude of the projection apparatus becomes stationary.
(Appendix 3) In the projection method according to Appendix 1 or 2, the first correction calculation is performed based on output from a first sensor for detecting an attitude of the projection apparatus, and the second correction calculation is performed based on output from a second sensor for detecting a condition of the projection target.

According to the projection method, the shape of the projection image may be appropriately corrected based on the output from the sensor suitable for each of the first correction calculation and the second correction calculation.
(Appendix 4) In the projection method according to Appendix 1 or 2, the first correction calculation is performed based on output by a first number of times from a second sensor for detecting a condition of the projection target, and the second correction calculation is performed based on output by a second number of times larger than the first number of times from the second sensor.

According to the projection method, since both the first correction calculation and the second correction calculation are performed based on the output from the common sensor, the calculation algorithm can be shared between the first correction calculation and the second correction calculation.
(Appendix 5) In the projection method according to any one of Appendices 1 to 4, a form of a peripheral edge of the first projection image is different from a form of another area than the peripheral edge of the e first projection image.

According to the projection method, the user can easily determine that the projection image is the first projection image, that is, the correction calculation is still being continued based on the form of the peripheral edge of the projection image.
(Appendix 6) In the projection method according to Appendix 5, the peripheral edge of the first projection image is blurred.

According to the projection method, even when the contour of the projection image based on the first correction calculation is tilted, the tilt can be obscured.
(Appendix 7) A projection apparatus comprises a projection optical system containing a lens for projecting a projection image on a projection target, and one or more processors, wherein the one or more processors execute performing a first correction calculation for correcting a shape of the projection image, causing the projection optical system to project a first projection image as the projection image based on a calculation result of the first correction calculation on the projection target, performing a second correction calculation for correcting the shape of the projection image, and causing the projection optical system to project a second projection image as the projection image based on a calculation result of the second correction calculation on the projection target, a processing time for obtaining the calculation result of the first correction calculation is a first time, a processing time for obtaining the calculation result of the second correction calculation is a second time longer than the first time, and the one or more processors cause the projection optical system to project the first projection image on the projection target prior to causing the projection optical system to project the second projection image on the projection target.

According to the projection apparatus, the first projection image is projected on the projection target prior to the projection of the second projection image on the projection target. That is, the first projection image corrected in a shorter time is projected until the second projection image corrected in a longer time is projected on the projection target. Therefore, an uncomfortable feeling caused by a long waiting time until the second projection image is projected on the projection target may be reduced.
(Appendix 8) A non-transitory computer-readable storage medium storing a program, the program is for a computer controlling a projection apparatus comprising a projection optical system including a lens for projecting a projection image on a projection target to execute performing a first correction calculation for correcting a shape of the projection image, causing the projection optical system to project pa first projection image as the projection image based on a calculation result of the first correction calculation on the projection target, performing a second correction calculation for correcting the shape of the projection image, and causing the projection optical system to project a second projection image as the projection image based on a calculation result of the second correction calculation on the projection target from the projection optical system, wherein a processing time for obtaining the calculation result of the first correction calculation is a first time, a processing time for obtaining the calculation result of the second correction calculation is a second time longer than the first time, and the computer causes the projection optical system to project the first projection image on the projection target prior to causing the projection optical system to project the second projection image on the projection target.

According to the program, the first projection image is projected on the projection target prior to the projection of the second projection image on the projection target. That is, the first projection image corrected in a shorter time is projected until the second projection image corrected in a longer time is projected on the projection target. Therefore, an uncomfortable feeling caused by a long waiting time until the second projection image is projected on the projection target may be reduced.

What is claimed is:

1. A projection method of a projection image projected from a projection apparatus, comprising:
correction calculation for performing a first correcting a shape of the projection image;
projecting a first projection image as the projection image based on a calculation result of the first correction calculation on a projection target;
performing a second correction calculation for correcting the shape of the projection image; and
projecting a second projection image as the projection image based on a calculation result of the second correction calculation on the projection target, wherein
a processing time for obtaining the calculation result of the first correction calculation is a first time,
a processing time for obtaining the calculation result of the second correction calculation is a second time longer than the first time, and
the first projection image is projected on the projection target prior to the projection of the second projection image on the projection target.

2. The projection method according to claim 1,
wherein whether a variation range of an attitude of the projection apparatus falls within a first range is determined based on output from a first sensor for detecting the attitude, and
when a determination that the variation range does not fall within the first range is made, the first projection image is projected on the projection target and, when a determination that the variation range falls within the first range is made, the second projection image is projected on the projection target.

3. The projection method according to claim 1, wherein
the first correction calculation is performed based on output from a first sensor for detecting an attitude of the projection apparatus, and
the second correction calculation is performed based on output from a second sensor for detecting a condition of the projection target.

4. The projection method according to claim 1, wherein
the first correction calculation is performed based on output by a first number of times from a second sensor for detecting a condition of the projection target, and
the second correction calculation is performed based on output by a second number of times larger than the first number of times from the second sensor.

5. The projection method according to claim 1, wherein
a form of a peripheral edge of the first projection image is different from a form of another area than the peripheral edge of the first projection image.

6. The projection method according to claim 5, wherein
the peripheral edge of the first projection image is blurred.

7. A projection apparatus comprising:
a projection optical system including a lens for projecting a projection image on a projection target; and
one or more processors, wherein
the one or more processors execute
performing first correction calculation for correcting a shape of the projection image,
causing the projection optical system to project a first projection image as the projection image based on a calculation result of the first correction calculation on the projection target,
performing a second correction calculation for correcting the shape of the projection image, and
causing the projection optical system to project a second projection image as the projection image based on a calculation result of the second correction calculation on the projection target,
a processing time for obtaining the calculation result of the first correction calculation is a first time,
a processing time for obtaining the calculation result of the second correction calculation is a second time longer than the first time, and
the one or more processors cause the projection optical system to project the first projection image on the projection target prior to causing the projection optical system to project the second projection image on the projection target.

8. A non-transitory computer-readable storage medium storing a program, the program for a computer controlling a projection apparatus comprising a projection optical system including a lens for projecting a projection image on a projection target to execute:
performing a first correction calculation for correcting a shape of the projection image;
causing the projection optical system to project a first projection image as the projection image based on a calculation result of the first correction calculation on the projection target;
performing a second correction calculation for correcting the shape of the projection image; and
causing the projection optical system to project a second projection image as the projection image based on a calculation result of the second correction calculation on the projection target, wherein
a processing time for obtaining the calculation result of the first correction calculation is a first time,
a processing time for obtaining the calculation result of the second correction calculation is a second time longer than the first time, and
the computer causes the projection system to project the first projection image on the projection target prior to causing the projection system to project the second projection image on the projection target.
